(19) United States
(12) Patent Application Publication
(10) Pub. No.: US 2026/0208684 A1
(43) Pub. Date: Jul. 23, 2026

(54) MOTOR VEHICLE DEFLECTOR COMPRISING DEFORMABLE CELLS

(71) Applicant: STELLANTIS AUTO SAS, Poissy (FR)

(72) Inventors: Jerome BAUMER, TRAUBACH LE HAUT (FR); Gaetan ROLLIN, HERICOURT (FR)

(21) Appl. No.: 19/140,824

(22) PCT Filed: Dec. 4, 2023
(86) PCT No.: PCT/FR2023/051915

§ 371 Date: Jun. 18, 2025

(30) Foreign Application Priority Data
Jan. 5, 2023 (FR) FR2300118

(51) Int. Cl. B60R 19/54; B62D 35/02

(52) U.S. Cl. CPC B60R 19/54; B62D 35/02

(57) ABSTRACT

The invention relates to a deflector (1) intended to be mounted on the underbody structure (3) of a motor vehicle and comprising a protective wall (4) in which at least one cell (5) is formed, the cell (5) comprising a side wall (6) and a base (7) positioned at an inner end (11) of the cell (5), the base (7) comprising a hole (8) intended to receive a securing part (9) for securing the cell (5) to the underbody structure (3). The side wall (6) of the cell (5) comprises at least one elongate slit (10) extending over the height of the cell (5).

### CROSS-REFERENCE TO RELATED APPLICATIONS

This application is the US National Stage under 35 USC § 371 of International Application No. PCT/FR2023/051915, filed Dec. 4, 2023, which claims the priority of French application 2300118 filed on Jan. 5, 2023, the content (text, drawings and claims) of both said applications being incorporated by reference herein.

### BACKGROUND

The devices described herein relate to the field of motor vehicles comprising an underbody structure under which a deflector is mounted. A motor vehicle commonly comprises an underbody structure under which components and equipment items are mounted. Fairing elements, such as at least one deflector, are also attached to the underbody structure, under the vehicle body, to cover the equipment items.

The deflector has several functions. It provides protection for underbody-mounted equipment items, notably against splashes of water or gravel, but also potentially against impacts with objects on the road. The deflector is aerodynamically shaped to improve vehicle stability and/or reduce drag. Finally, the deflector can also be configured to channel air flowing under the body, for example to supply a vehicle cooling circuit.

The deflector is a substantially flat part comprising a lower face facing the road and an upper face in contact with the vehicle body. The deflector is typically attached to the underside of the body using securing parts such as nuts or screws.

To ensure the aerodynamic function of the deflector, the securing parts are generally mounted in cells or shafts formed in the lower face of the deflector.

Document FR3119826 discloses a deflector comprising a wall in which at least one cell is formed. The cell comprises a side wall and a base comprising a hole for receiving a nut for securing the cell to the underbody structure.

Depending on the body environment and aerodynamic limitations, the deflectors may comprise protruding parts located locally outside the vehicle's ground clearance, that is to say protruding from the ground clearance and directed toward the ground. This means there is a risk of the deflector breaking against a curb, for example.

To eliminate this risk, the current solution is to reduce or cut the deflectors to bring them up to ground clearance level, but at the expense of aerodynamic surface area.

This goes against the need for maximum under-body protection and maximum aerodynamic performance.

### SUMMARY

The aim is therefore to overcome the disadvantages of the prior art by proposing an under-body deflector capable of absorbing impacts in such a way as to be able to comprise portions protruding beyond the ground clearance.

To this end, the described devices thus relate, in their broadest sense, to a deflector designed to be mounted on an underbody structure of a motor vehicle and comprising a protective wall in which at least one cell is formed. The cell comprises a side wall and a base positioned at an inner end of the cell. The base comprises a hole for receiving a securing part for attaching the cell to the underbody structure.

The side wall of the cell comprises at least one elongate slit extending over the height of the cell.

Thus provided is an under-body deflector capable of absorbing impacts in such a way as to be able to comprise portions protruding beyond the ground clearance.

The proposed solution retains the shape of the current deflectors with maximum under-body coverage, ensuring optimum protection and maximum aerodynamic function. The deflector can thus have parts protruding toward the ground and beyond the ground clearance, without the risk of damage.

The cells act like fuses. The cells deform in the event of impacts of part of the deflector protruding beyond the ground clearance, for example against a curb.

When the sidewalk is passed, the cells return to their original shape. The risk of deflector breakage is avoided.

Furthermore, impact absorption by the cells means that impacts are not transmitted to parts protected by the deflector.

According to one alternative, each slit extends into the side wall from the inner end of the cell toward an outer end of the cell opposite the inner end. The outer end is connected to an outer part of the protective wall.

This configuration ensures maximum slit elongation to increase the cell's capacity to absorb impacts.

According to another alternative, the side wall of the cell has a generally frustoconical shape with an axis of revolution. The side wall comprises a plurality of slits evenly spaced about the axis of revolution.

This distribution provides the flexibility needed for the cell to deform and absorb an impact.

According to another alternative, each slit and the axis of revolution lie in the same plane. The slit is inclined to the axis of revolution.

This configuration optimizes the flexibility of the cell, while retaining the rigidity required to hold it in place on the underbody structure.

According to another alternative, each slit extends from the base to the vicinity of the outer part of the protective wall.

According to another alternative, the side wall of the cell comprises a frustoconical main part connected to a curved border. The curved border is connected to the outer part of the protective wall. The slit extends along the main part and the curved border, from the base to the vicinity of the outer part of the protective wall.

This solution provides maximum slit length to optimize its deformation.

According to another alternative, the slit comprises a straight portion extending into the main part of the side wall of the cell and a curved portion extending into the curved border.

According to another alternative, the slit is between 4 cm and 8 cm long.

According to another alternative, the slit is between 1 mm and 3 mm wide.

The described devices also relate to a motor vehicle comprising an underbody structure on which a deflector as previously defined is mounted.

### BRIEF DESCRIPTION OF THE FIGURES

A description will be given below, by way of non-limiting examples, of embodiments, with reference to the attached figures wherein:

FIG. 1 schematically shows a bottom view of a motor vehicle comprising a deflector equipped with cells;

FIG. 2 schematically shows a detailed view of a cell from FIG. 1; and

FIG. 3 schematically shows a longitudinal sectional view of the deflector from FIG. 1.

### DETAILED DESCRIPTION

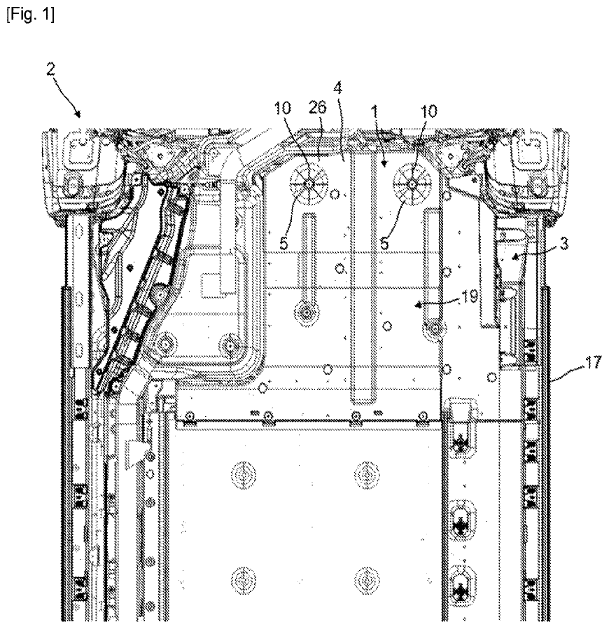

FIG. 1 shows a bottom view of a motor vehicle 2 comprising a body 17 with an underbody structure 3.

The underbody structure 3 comprises a plurality of fairing elements, including a deflector 1 which forms a fairing profile designed to improve the aerodynamic properties of the motor vehicle 2, such as its drag, for example. The fairing elements also act as protective shields for equipment items on the motor vehicle 2. The fairing elements can also have other functions, such as participating in a cooling system.

The deflector 1 comprises a protective wall 4 with a lower face 19, which in use is positioned facing the driving surface such as the road. The deflector 1 is therefore positioned under the body 17.

The deflector 1 has a substantially flat shape, optionally with protuberances. The deflector 1 comprises an upper face 20 attached to the underbody structure 3. The deflector 1 is made of a polymer.

The example in FIG. 1 shows two cells 5 formed in the protective wall 4 of the deflector 1 to accommodate a securing part 9 for attaching the deflector 1 to the body 17 of the motor vehicle 2. The securing part 9 can be a nut or a screw, to attach the deflector 1. In this example, the securing element 9 is a screw 21 comprising a shank inserted into the underbody structure 3 and a head 22.

The screw 21 is preferably made of plastic, but metal can also be used to form the screw 21.

To provide the aerodynamic function of the deflector 1, the screw 21 is mounted in one of the cells 5.

Each cell 5 is connected to an outer part 26 of the protective wall 4 and comprises a side wall 6 and a base 7 positioned at an inner end 11 of the cell 5, as shown in FIG. 2. The base 7 is flat and comprises a circular hole 8 for receiving the securing part 9.

The cell 5 has an elongate profile and projects from the upper face 20 of the deflector 1, facing the underbody structure 3.

The cell 5 is generally frustoconical and has an axis of revolution R. It can also be cylindrical.

The cell 5 is, for example, formed at the same time as the protective wall 4 during a step of molding the deflector 1.

The side wall 6 of the cell 5 comprises at least one elongate slit 10 extending over the height of the side wall 6.

In other words, the slit 10 extends into the side wall 6 from the inner end 11 of the cell 5 toward an outer end 12 of the cell 5, opposite the inner end 11. The outer end 12 is connected to the outer part 26 of the protective wall 4.

The slit 10 is a longitudinally-shaped opening created in the side wall 6, forming a perforated cell 5.

The outer part 26 is the substantially flat part of the deflector 1 which protects the elements of the underbody structure 3.

In the example shown in FIGS. 1 to 3, the side wall 6 comprises a number of slits 10 evenly distributed about the axis of revolution R. More specifically, the side wall 6 comprises eight slits 10 in this example.

Each slit 10 and the axis of revolution R lie in the same plane. The slit 10 is inclined to the axis of revolution R at an angle of between 20° and 70°.

The slits 10 can be oriented so that their respective ends converge on the same point by projection.

Alternatively, the slits 10 can be oriented so that their respective ends do not converge on the same point by projection.

Alternatively, each slit 10 and the axis of revolution R may not lie in the same plane.

Each slit 10 extends from the base 7 to the vicinity of the outer part 26 of the protective wall 4, without reaching the outer part 26.

Alternatively, each slit 10 extends from the base 7 to the outer part 26 of the protective wall 4.

Strips 28 or lamellae are formed in the side wall 6 of the cell 5 between slits 10. These strips 28 are deformable and locally movable relative to one another. The strips 28 have a generally trapezoidal shape in this example. The strips 28 are attached to the base 7, at the inner end 11 of the cell 5, and attached to the outer part 26 of the protective wall 4, at the outer end 12 of the cell 5.

The side wall 6 of the cell 5 comprises a frustoconical main part 13 which is connected to a curved border 14 positioned at the outer end 12 of the cell 5. The curved border 14 has a generally annular shape with a curved cross section along an axial section passing through the axis of revolution R. The curved border 14 comprises a first edge 23 connected to the main part 13 and a second edge 24 connected to the outer part 26 of the protective wall 4 of the deflector 1.

Preferably, the slit 10 extends through the main part 13 from the base 7 and continues in the curved border 14 to the vicinity of the outer part 26 of the protective wall 4 of the deflector 1, that is to say the slit 10 stops short of the outer part 26. The slit 10 may optionally extend to the outer part 26.

Each slit 10 comprises a straight portion 15 extending along the main part 13 of the side wall 6 of the cell 5 and a curved portion 16 extending along the curved border 14.

For example, the slit 10 is between 4 cm and 8 cm long and between 1 mm and 3 mm wide.

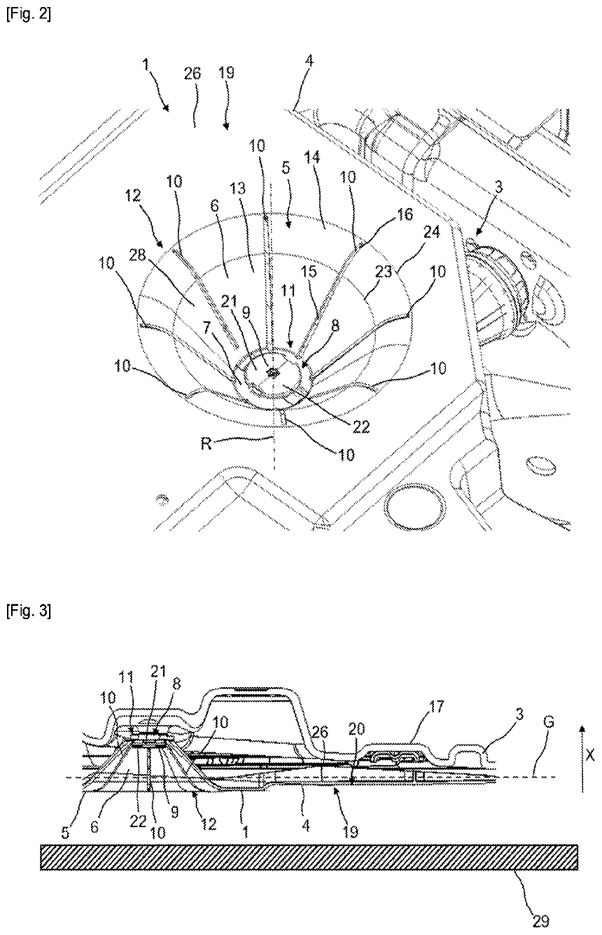

FIG. 3 shows part of the deflector 1 facing a road 29 on which the motor vehicle 2 is traveling. The part of the deflector 1 protrudes above the ground clearance of the motor vehicle 2, that is to say it is positioned below a ground clearance limit G of the motor vehicle 2, along a vertical direction X. The front bumper may be above the ground clearance limit G, for example.

However, when this part of the deflector 1 encounters a sidewalk, it deforms and moves toward the underbody structure 3, in a direction away from the road 29, without being damaged due to the cell 5. This part of the deflector 1 returns to its original shape and position once the curb has been passed.

The cell 5 has absorbed the impact and mechanical stress due to the thrust exerted by the sidewalk on the outer part 26 of the protective wall 4 of the deflector 1, which protrudes beyond the ground clearance limit G. The side wall 6 of the cell 5 is deformed by the slits 10, which allow deformation of the strips 28 formed between the slits 10.

When the curb is passed, the strips 28 return to their original position and the deflector 1 remains intact.

1. A deflector intended to be mounted on the underbody structure of a motor vehicle and comprising a protective wall in which at least one cell is formed, the cell comprising a side wall and a base positioned at an inner end of the cell, the base comprising a hole intended to receive a securing part for securing the cell to the underbody structure, wherein the side wall of the cell comprises at least one elongate slit extending over the height of the cell.

2. The deflector according to claim 1, wherein each slit extends into the side wall from the inner end of the cell and toward an outer end of the cell, opposite the inner end, and connected to an outer part of the protective wall.

3. The deflector according to claim 2, wherein the side wall of the cell has a generally frustoconical shape with an axis of revolution, the side wall comprising a plurality of slits evenly distributed about the axis of revolution.

4. The deflector according to claim 3, wherein each slit and the axis of revolution lie in the same plane, the slit being inclined to the axis of revolution.

5. The deflector according to claim 2, wherein each slit extends from the base to the vicinity of the outer part of the protective wall.

6. The deflector according to claim 5, wherein the side wall of the cell comprises a frustoconical main part which is connected to a curved border, the curved border being connected to the outer part of the protective wall, the slit extending along the main part and the curved border, from the base to the vicinity of the outer part of the protective wall.

7. The deflector according to claim 6, wherein the slit comprises a straight portion extending into the main part of the side wall of the cell and a curved portion extending into the curved border.

8. The deflector according to claim 1, wherein the slit is between 4 cm and 8 cm long.

9. The deflector according to claim 1, wherein the slit is between 1 mm and 3 mm wide.

10. A motor vehicle, wherein it comprises an underbody structure on which a deflector as defined according to claim 1 is mounted.
